(19) United States
(12) Patent Application Publication
(10) Pub. No.: US 2018/0116252 A1
(43) Pub. Date: May 3, 2018

(54) SYSTEMS, COMPONENTS & METHODS FOR THE PREPARATION OF CARBON-NEUTRAL CARBONATED BEVERAGES

(71) Applicant: Graciela Chichilnisky, New York, NY (US)

(72) Inventor: Graciela Chichilnisky, New York, NY (US)

(21) Appl. No.: 15/830,394

(22) Filed: Dec. 4, 2017

Related U.S. Application Data
(63) Continuation of application No. 14/250,924, filed on Apr. 11, 2014, now abandoned.
(60) Provisional application No. 61/810,486, filed on Apr. 10, 2013.

(51) Int. Cl. A23L 2/54; A47J 31/44; B01F 15/02; B01F 3/04; B01D 53/06; B01D 53/047; B01D 53/02

(52) U.S. Cl. CPC A23L 2/54; B01D 2256/22; B01D 53/02; A47J 31/44; B01F 15/026; B01F 3/04815; B01F 3/04808; B01F 2215/0022; B01D 53/06; B01D 53/047; B01D 2258/06; B01D 2259/4009; Y02C 10/08; B01D 2253/202; B01D 2257/504; B01D 2258/0283

(57) ABSTRACT

A system for the preparation of carbon-neutral carbonated beverages utilizing carbon-neutral carbon dioxide, comprising a storage vessel of pressurized (of at least about 120 psi) purified carbon dioxide, captured from ambient air or a mixture of ambient air with a minor proportion of flue gas effluent, by a process of adsorbing the carbon dioxide on a solid sorbent and separating and the carbon dioxide from the adsorbent using waste process heat, while regenerating the sorbent for further adsorption; a source of flowing potable aqueous liquid at a lower pressure than the storage vessel of carbon dioxide; a carbonator vessel in fluid flow connection with the source of flowing aqueous liquid and the storage vessel of pressurized, purified carbon dioxide, through suitable regulating valves to set the pressure in the carbonator dependent upon the temperature of the potable water; and dispensing means for passing carbonated liquid from the carbonator to a container for immediate consumption or to a sealed container for storage and subsequent use.

This application is a continuation of U.S. application Ser. No. 14/250,924 filed Apr. 11, 2014, and claims the benefit of priority pursuant to 35 U.S.C. 119(e) from two U.S. provisional patent applications: Application No. 61/446,399, filed Feb. 24, 2011, and Application No. 61/447,312, filed Feb. 28, 2011.

### BACKGROUND OF THE INVENTION

The present invention relates generally to systems and methods for making more environmentally desirable the carbonation of beverages, i.e., to make it carbon-neutral, by the use of carbon dioxide, CO₂, removed directly from the ambient air, or from a mixture of ambient air and a minor percentage of flue-originated gases. The term “ambient air”, as used in this specification, means and includes unenclosed air under the conditions and concentrations of materials present in the atmosphere at a particular location.

In carrying out the present invention, the CO₂ can be captured from ambient air in accordance with the procedures previously disclosed in copending, commonly-owned, provisional Applications Ser. Nos. 61/210,296, filed Mar. 17, 2009, and 61/330,108, filed Apr. 30, 2010, and 61/643103, filed May 4, 2012; and U.S. Publication No. 2011-0296872, which is incorporated herein by reference as if fully repeated.

### INVENTION BACKGROUND CONTEXT

Much effort has been focused on achieving a reduction in the concentrations of so-called ‘greenhouse gases’, especially carbon dioxide (CO₂) in the Earth's atmosphere, and rendering industrial processes carbon-neutral or carbon-negative in effect. The aforesaid procedures are especially effective in achieving such reduction and with the generation of high purity CO₂, of sufficient purity to be used in preparing potable liquids.

Today, many carbonated beverages are taken from natural sources, thereby ultimately removing the CO₂ from a naturally protective underground storage situation out of the atmosphere and ultimately releasing it to the atmosphere; alternatively, CO₂ is artificially generated by chemical means, thereby also releasing otherwise trapped CO₂, for example from natural carbonate sources, ultimately to the atmosphere as the carbonated beverage is used in drinks.

By utilizing the CO₂ removed, or captured, from ambient air by the aforedescribed CO₂ removal processes, there is no additional CO₂ added to the air, even as all of the carbonated beverage is used, and at worst provides at least a temporary removal of the CO₂ from the atmosphere.

### SUMMARY OF THE PRESENT INVENTION

The present invention teaches systems, and methods capable of utilizing captured carbon dioxide from ambient air alone, or from a mixture of ambient air and a minor percentage of flue-originating gases, in the preparation of carbon-neutral, carbonated water.

The present invention provides a carbon-neutral carbonated water by removing carbon dioxide from the ambient atmosphere by directing the CO₂-laden ambient air through a sorbent structure that selectively removably binds (captures) CO₂, preferably under ambient conditions, and removing (stripping) CO₂ from the sorbent structure (and thereby effectively regenerating the sorbent structure) by using process heat, preferably in the form of low temperature steam, at a temperature preferably of not greater than 120° C. to heat the sorbent structure and to strip off the CO₂ from the sorbent structure; pressurizing the thus captured high purity CO₂ to a pressure of at least 50 psi, and stored in large storage tanks until needed.

The CO₂ for carbonation would normally be provided to ultimate users, in high pressure cylinders about 10 ins. in diameter and slightly less than 5 feet in length. Those cylinders can be pressurized to about 600 to about 850 psi, and fitted with valves for dispensing the CO₂ for lower pressure uses. When the high pressure storage tanks are filled with the compressed gas near the CO₂ capture plants, the heat generated by the pressurization of the captured CO₂ can be used to supplement the process heat for the stripping of the CO₂ from the sorbent. The pressurized CO₂ can also be provided to the ultimate user, in smaller containers, including, by way of example, small cartridges suitable for carbonating a liter or less of aqueous liquid.

When the CO₂ is pressurized to 830 psi, and put into the cylinders, it usually passes into a liquid phase, which allows for the storage of even greater quantities of CO₂ in the cylinders.

The process of dissolving carbon dioxide in water, or carbonation, has long been known, and generally involves passing pressurized CO₂ into chilled water, generally at a temperature of not greater than 8° C., and pressurizing the water with CO₂ to about 120 psi, in a closed container. This general procedure is followed when preparing individual size containers of carbonated water, such as 2 liters or smaller amounts.

Commercially operated systems for preparing large batches, or continuous flows, of carbonated water follow a somewhat different procedure, at least in the United States. In such processes, room temperature water can be used together with higher pressure CO₂. Specifically, higher-pressure CO₂ is fed into a continuous flow of relatively warm, e.g., room temperature, tap water. The carbonated water is then chilled before use, so as to avoid the release of most of the dissolved CO₂ when the pressure is released. One example of such a unit consists of a Proconn™ electric water pump, a stainless steel pressure vessel with electronic water level control, and associated connections and check valves. The bottom half of the pressure vessel contains water; the top half is initially purged of air and thereafter contains only CO₂ gas. The CO₂ regulator is set to supply CO₂ at about 100 psi, which maintains the same pressure in the vessel. The pump boosts the tap water pressure from the utility supply (typically about 60 psi) to something higher that will inject water past a check valve and into the 100 psi vessel. An electronic level control monitors the amount of water in the vessel and turns on the pump to maintain the water level as carbonated water is withdrawn. The carbonated water output is removed from the bottom of the vessel via a dip tube, and through a pressure relief valve. An overpressure relief valve on the tank ensures that if the CO₂ pressure becomes dangerously high (such as from a jammed-open CO₂ regulator) that the pressure vessel would not catastrophically explode.

The large area of interface between the gas and liquid in the pressure vessel, and the high pressure of CO₂, result in rapid dissolution of CO₂ into the water, even at room temperature. The equilibrium of this solution, given the high pressure of CO₂, is above the target 4 volumes of CO₂ despite the room temperature operation. In the so-called improvised bottle method, chilling and agitation is used to rapidly carbonate; in the carbonator machine high pressure and a larger surface area allows for continuous carbonation of flowing water.

To maintain the carbonation at the ultimate intended delivery pressure, it is necessary to lower the temperature of the liquid after it flows from the carbonator vessel but before dispensing it to atmospheric pressure. Chilling is absolutely critical to dispensing carbonated beverages. Dispensing at room temperature results in an instantaneous loss of nearly all the carbonation (“warm soda is flat soda”) due to the agitation of passing through the valve. Thus, many commercial carbonation and dispensing systems use a “flash” chiller to lower the temperature of the flowing seltzer just before it reaches the dispenser valve.

When used for carbonating chilled water, the pressure reduction valve on each cylinder of captured CO₂ will allow for the pressurization of the CO₂ into the water to a pressure of at least about 20 psi up to about 70 psi, if desired. Carbonation at room temperatures, i.e., up to about 20°-30° C., can be accomplished by operating at the higher pressures. References to “psi” in this description refer to gauge pressure above ambient atmosphere.

For details of the CO₂ capturing process, the specification and drawings of the aforedescribed provisional applications are incorporated herein by reference, as if fully repeated. Any other process for removing high purity CO₂ from ambient air can be used as now known or as may be developed in the future, so long as the process provides the necessary purity and pressure of CO₂.

In a preferred example of such a process, the term “process heat” as used herein refers to the relatively lower temperature heat remaining after the higher temperature heat has been used for a primary process, e.g., to generate electricity, or any low temperature heat that is added by the process itself, such as, for example, exothermic carbonation reactions in which carbon dioxide is stored as a mineral or in fact when it binds to a sorbent medium and is captured. Primary processes more generally that result in ‘process heat’ can include, for example, chemical processing, production of cement, steel or aluminum, production of energy products like converting coal to liquid energy products, and oil refining. One preferred way of providing process heat is by a co-generation process, in which a primary process (e.g. for generating electricity) provides a source of process heat (either directly in the form of steam, or in a form that can be used to heat a body of liquid to produce steam). That process heat is further used in the manner described herein to generate steam to remove, or strip, CO₂ from a sorbent-carrying substrate and to regenerate the sorbent carried by the substrate.

According to the present invention, which will be described in detail below, and which may be used in conjunction with either industrial or energy-producing plants or factories, for example, utilizing carbon-based fuel, non-carbon-based fuel, and/or heat/energy from nuclear, geothermal, wind or solar systems. Process heat, independent of emissions, or in combination with a relatively small percentage of carbon-based emissions, is utilized to co-generate steam, by means of a heat exchanger. Air, alone, or mixed with a flue gas effluent in an air/flue gas “blender,” is conducted to and into contact with a sorbent alternately moved between carbon dioxide capture and regeneration positions. After the step of carbon dioxide capture, the sorbent is moved to a “stripping” or regeneration position, where steam co-generated by means of the process heat is used to “strip” the carbon dioxide from the sorbent, and recovered, whereupon the capturing and regeneration cycles are repeated.

The advantage of capturing CO₂ at ambient temperatures is made possible by the unexpected effect of the operation of steam stripping. First, it was discovered that when the CO₂ is captured at ambient conditions from air, the CO₂ can be stripped from the sorbent at relatively low temperatures, e.g., steam at atmospheric pressure. Further, the reason that such low temperature steam may be used is the mechanism of the steam. As the steam front proceeds into and through the sorbent structure, it gradually heats the stricture as the steam condenses. Behind the steam front one will have a low partial pressure of CO₂, as a result of the presence of steam, which will encourage more CO₂ to be stripped off. Thus, the steam is functioning behind the steam front as a sweep, or purge, gas. That is, in front the steam is driving off the CO₂ by heat, and behind by partial pressure dilution.

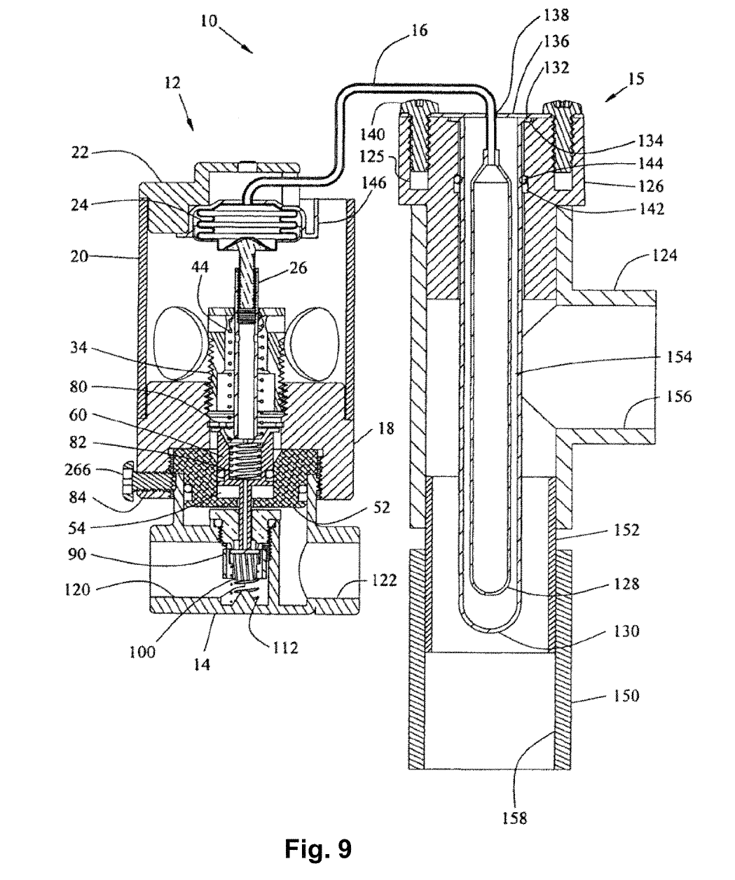

It has been found that this process is successful with almost any admixture with ambient air that comprises at least a predominant quantity of ambient air, by volume, to dilute the flue-originated gases. The flue-originated gases will greatly increase the concentration of CO₂ in the mixture, as compared with the ambient air, and are fully mixed into the air by a system, for example, as shown in FIGS. 25 and 26 of the prior co-pending published application No. US2011/0296872, to form a substantially uniform, high CO₂-content gas mixture.

The CO₂ laden gas mixture, at ambient temperature, is treated by directing it through a sorbent structure comprising a relatively thin, high surface area, porous monolith, supporting active CO₂-sorbent sites, that can bind (capture) CO₂, and then regenerating the sorbent by causing the release of the sorbed CO₂ from the sorbent, by treating the sorbent structure with low temperature, preferably saturated, process steam, at a temperature of not greater than about 120° C., and withdrawing the released CO₂ (thereby effectively regenerating the sorbent structure) and obtaining high quality CO₂.

In this application, the monolith structure preferably comprises an amine that binds to CO₂, and which is carried by a substrate structure. The sorbent will be preferably held on the surfaces of the substrate, including the surfaces within the pores. It was previously thought that when carbon dioxide concentration was much above that of ambient air, the CO₂ sorbent temperature would be too high due to the exothermic heat from the adsorption of the CO₂, which would raise the temperature of the monolith. It is known that the effectiveness of the sorbent, in the presence of air, would be degraded, at such higher temperatures. It was expected that the effectiveness for capturing CO₂, would be diminished, and would require a higher temperature to regenerate the sorbent.

It is known that the fraction captured by adsorption depends inversely upon the temperature of the sorbent, in a way given by its Langmuir isotherm; for the available primary amine sorbents. The isotherm is exponential with temperature, because of the adsorbent's high heat of reaction with CO₂, i.e., about 84 kj/mole. For example, a temperature increase from 25° C. to 35° C. reduces the percent of amine sites that can capture CO₂, at equilibrium, by about e⁻¹. As a result, the ambient temperatures in cold weather, i.e., winter in the mid or higher latitudes or elevations, reduce this problem, or allow a higher concentration of CO₂ to be treated. For example, if the ambient temperature is 15° C., a rise of 10° C. would yield the same performance as the 25° C. case ambient location treating a lower concentration of CO₂. The Langmuir isotherm for a primary amine is close to optimal at about 15° C. in terms of the fraction of amine sites in equilibrium and the sensible heat needed to strip and collect CO₂ from the sorbent, so as to regenerate the sorbent effectively at about 100° C. A conceptual design is shown in FIG. 27, where the effluent gas is fully mixed with the air through a suitable apparatus, and the temperature rise is analyzed.

A particularly efficient embodiment of this invention is achieved if it is integrated into a CO₂ generating process, such as a power plant, which includes a prior art treatment process, which at the least removes particulates and sorbent poisons, such as oxides of sulfur and nitrogen. Generally, most coal-burning plants in North America or Europe provide a post-combustion treatment using a process generally referred to as CSS technologies.

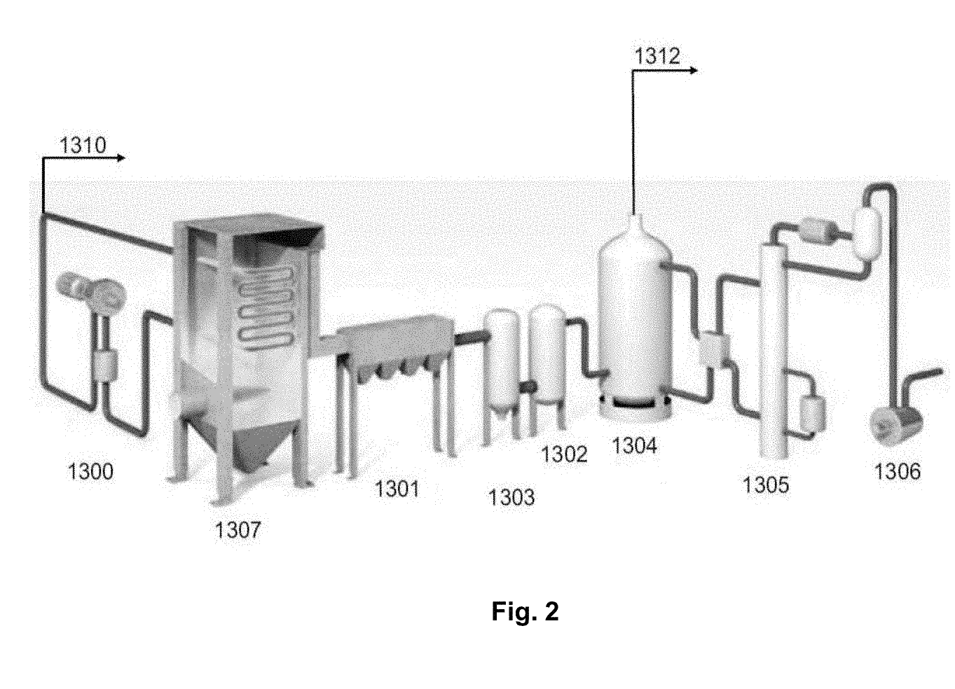

One generally used such process is the so-called “post-combustion MEA process”, as practiced by the Costain Group PLC, of England, and as shown diagrammatically in FIG. 2, showing its use in a coal fired power plant, and its treated effluent being passed to the process of the present invention. The effluent from the CSS Process, which is free of particulates and the usual poisons of the sorbent used in the process of the present invention, is admixed with ambient air for treating with the present process to capture the combined CO₂. The incremental cost per tonne of CO₂ removal by the CSS Process increases sharply as one increases the percent of CO₂ removed from the gas mixture and becomes very costly as one goes from 90% to 95% removal. On the other hand, as one reduces the percent captured by the CSS Process, alone, it often becomes costly because the penalty for the CO₂ not captured increases in situations where CO₂ emissions are regulated, thus reducing the value of the whole process. For these reasons the target for CSS is usually 90%.

On the other hand, the costs per unit amount of pure CO₂ captured by the process of the present invention are reduced as the percent of CO₂ in the process stream entering the process of the present invention increases; this is especially effective when combined with the effluent from such a CSS Process, or other flue gas pretreatment. As the concentration of CO₂ in the feed stream increases, however, the process of the present invention must provide the necessary cooling means to insure that the temperature rise from the exothermic capture of the mixed CO₂ does not cause the degradation of the effectiveness of the sorbent. There is thus an opportunity to optimize the cost per tonne of CO₂ captured by calibrating the relative effect of the combination of the CSS Process and the present invention by reducing the percent of CO₂ removed in the CSS stage—say if one backs off to 80% removal of CO₂ in the prior art CSS Process, and mixing the remaining relatively high CO₂ content CSS effluent (containing, e.g., 2% CO₂) with ambient air. In that case, for every 1% of that CSS effluent stream one mixed with the air, one would increase by about 50% the CO₂ concentration in the gas mixture fed into the process of the present invention

The associated temperature rises can be determined, because the temperature rise depends on the rate of CO₂ adsorption and thus the concentration of CO₂ in the mixed process feed stream. If one mixed in 5% of the CSS effluent, it would reduce the capital costs for the process of the present invention by a factor of 3 (because the concentration is three (3) times higher in the mixed stream than in the air alone) over a stand-alone pure ambient air capture process. The temperature rise for that case is close to the rise when mixing the full flue gas stream version of the carburetor, or about 3.5° C. Most importantly, if the air capture process of the present invention were set to remove only 70% of the CO₂ from the mixed stream, the combined processes would remove over 100% of the CO₂ emitted by the power plant. It would thus produce carbon-free, or carbon-negative, electrical power or other product, having used the burning of fossil fuel as the energy source. In removing 75-80% of the CO₂, by the process of the present invention, from the mixed gases, the result would be a carbon-negative power-generating process.

Besides achieving direct benefits from reducing the cost per tonne of CO₂ collected, by having each process optimizing the cost of the other, there are also other benefits from process integration. These benefits include that the exhaust stream from the flue gas processing is clean, removing that problem/cost for the mixing step, and more efficient and lower cost use of energy. There are many different pre-combustion and post combustion CO₂ removal processes being pursued, other than the CSS Process, and new ones could well emerge in the future. The details of the amount mixed of the ambient air and the CSS effluent, and possible additional processing of the exhaust from the first stage flue gas process, will vary in detail but the basic advantages of the combined process remain qualitatively the same.

To allow for the capture from a higher concentration of CO₂ (by limiting the exothermic temperature rise), the present system allows condensed steam, as water, to remain in the monolith pores after the stripping of the CO₂ is completed, rapid evaporation of a portion of the hot condensate liquid is a highly useful tool to rapidly cool the monolith. The stripped, cooled monolith is then returned to the CO₂-capture station and for a further sorption step, while conserving the heat by preheating the CO₂-loaded sorbent preliminarily to stripping. The monolith and sorbent would otherwise be undesirably heated during the sorption step, and thus would be more susceptible to degradation when exposed to the CO₂-laden air. This effect is most readily achieved in a monolith having a thickness, or length in the direction of the incoming air flow, of preferably not more than 10% of the largest other dimension of the monolith, e.g., a thickness of fifteen (15) centimeters, and a length or width of at least two (2) meters, by 0.5 meters, i.e., a surface area, transverse to air flow, of at least 1 meter square. For more details, see U.S. Provisional Application No. 61/643,103, filed on May 4, 2012.

In accordance with one embodiment of this invention, the CO₂-capturing sorbent structure preferably comprises a monolith with (highly) porous walls (skeleton) that contains amine binding sites which selectively bind to CO₂. In another (second) embodiment, the sorbent structure comprises a monolith with porous walls (substrate) upon the surfaces, or in the pores, of which is deposited an amine group-containing material which selectively binds to the CO₂. According to one aspect of this other (second) embodiment, the monolithic highly porous skeleton has deposited on its surfaces a coating of a highly porous substrate formed of a material that selectively supports the amine-group containing material.

In yet another (third) embodiment of this invention, the amine-group containing material is carried by a substrate, which can be in the form of a bed of relatively small solid particles, including both a stationary and a moving bed.

Regardless of whether the substrate is a bed of particulate material or a monolithic form, the sorbent will be preferably supported on the surfaces (including the internal pore surfaces) of the substrate, or in yet another most preferred embodiment, the substrate itself is formed of a polymerized amine-containing skeleton. Most preferably, under conditions met in most countries, the amine sorbent is a polymer having only primary amine groups, i.e., the nitrogen atom is connected to two hydrogen atoms. However, where ambient conditions are at an extremely low temperature, e.g., less than 0° C., as may be found in most parts of Alaska, or Northern Scandinavia, it is believed that weaker binding secondary and tertiary amines can be effective, as they are for high concentration flue gas.

Reference to a “mass” (or “flow” or “stream”) of “CO₂ laden air” (or “carbon dioxide laden air”) in this application means and includes air at a particular location with a concentration of CO₂ that is similar to the concentration of CO₂ in the atmosphere at that particular location.

In one of its basic aspects, the system and method, in accordance with the present invention, are designed to be capable of capturing the carbon dioxide from the atmosphere, i.e., carbon dioxide laden air, under ambient conditions. Ambient conditions include substantially atmospheric pressure and temperatures in the range of from about −20° C. to about 35° C. It will be appreciated that outside (ambient) air, into which many sources exhaust, can also have variable constituents depending where it is located; specifically, locally, the CO₂ concentration can vary near highways or power plants and of course during the day and night. Thus, ambient air has no fixed CO₂ concentration, but is usually just less than 0.4% by volume.

The captured CO₂ is then stripped from the sorbent using process heat in the form of saturated steam, separating carbon dioxide from the sorbent and regenerating the sorbent. The saturated steam is preferably at a pressure of substantially at or near atmospheric pressure and a temperature of close to 100° C., i.e., up to about 130° C., with 105-120° C. being a preferred embodiment It should also be noted that the temperature of the incoming steam may be superheated at the pressure it is fed to the present process, i.e., at a higher temperature than would be the equilibrium temperature at the pressure of the sorbent structure, in the regeneration chamber. After the CO₂ is stripped from the sorbent, it can then be readily separated from the steam by the condensation of the steam d removal of the CO₂. The condensed still hot water, and any steam is recycled to the process steam generator to save the sensible heat energy. The CO₂ lean air is exhausted back to the outside (ambient) air.

Moreover, in yet another of its aspects, this invention is preferably carried out immediately adjacent to a carbon fuel-using industrial site, burning a carbon-containing fuel to provide heat and power to the site, and wherein a minor percentage, i.e., less than about 50% by volume of flue gas can be added to the air, and more preferably not more than 25% of flue gas. As before, it is important that the final mixed gases is limited to a CO₂ concentration at which the rate of CO₂ capture was not high enough that the exothermic heat released during adsorption would raise the temperature of the monolith loaded with the sorbent to the point that its effectiveness for capturing CO₂ was diminished, when considering the ambient conditions at which the process is being carried out. Accordingly, under very cold ambient conditions, such as in the higher latitudes, nearer to the poles, mixtures of gases containing higher concentrations of CO₂ can be treated without having to provide extremely large amounts of cooling capacity.

By combining with a CCS process, or other process for pre-treating flue gas to eliminate particulates and sorbent poisons, many of the problems associated with directly mixing the flue gas are avoided or at least minimized. Such problems with direct injection of flue gas include the high temperature of the flue gas, which creates several problems, including without limitation a requirement of extra cooling capacity: The amount of flue gas to be added to air is relatively small (less than 50% and preferably not more than 25% by weight) so that there is a small flue gas stream being introduced to a large air stream. The air stream and the flue gas stream are both at low pressure and so there is, effectively, no energy in these streams that can be used for mixing without increasing the pressure drop. The air stream could vary in temperature (depending upon the location of the plant) between −30° F. to +110° F. The higher temperature has an effect upon the volumetric flow and the power required for the fan. A low air temperature could impact the process as flue gas contains a significant amount of water and has a dew point range between 120° F. and 145° F., depending upon the type of fuel, excess air rates, moisture content of the combustion air, impurities, etc. Thus, if the flue gas is not mixed well with the air or the flue gas ducting is contacted by cold ambient air, condensation may occur. Flue gas that is not pre-treated will result in a condensate that is corrosive. This is another reason for the pre-treatment in addition to the requirement of potability when the CO₂ product is to be used for making carbonated beverages. The pretreatment must result in a suitably benign gas.

These and other features of this invention are described in, or are apparent from, the following detailed description, and the accompanying drawings and exhibits.

### BRIEF DESCRIPTION OF THE SEVERAL VIEWS OF THE DRAWING

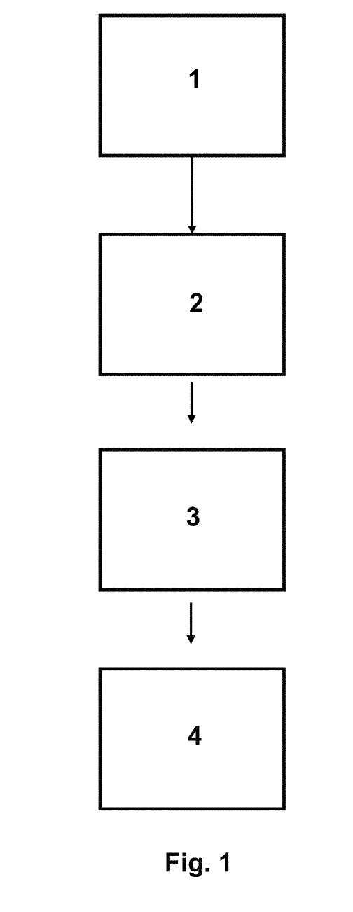

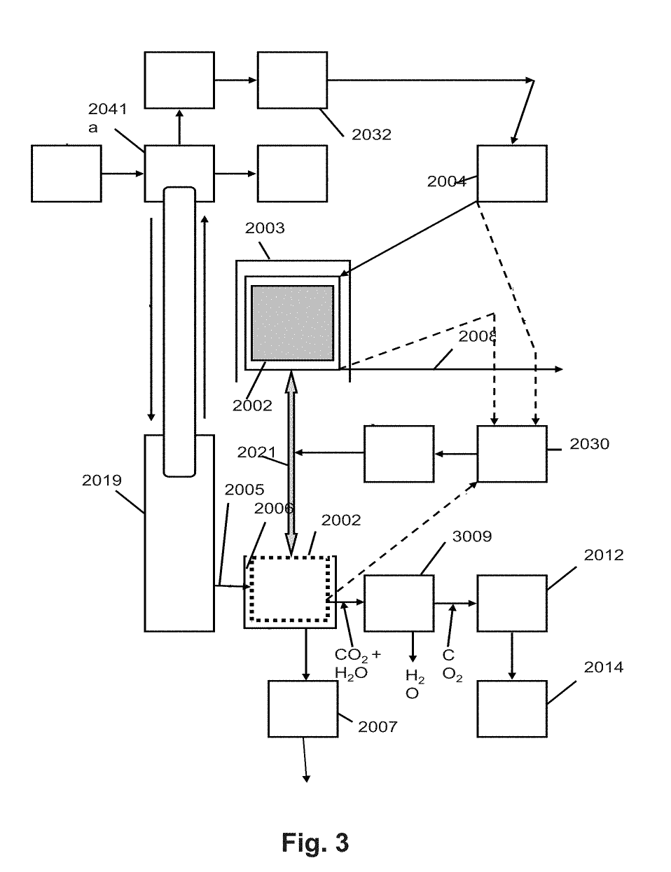

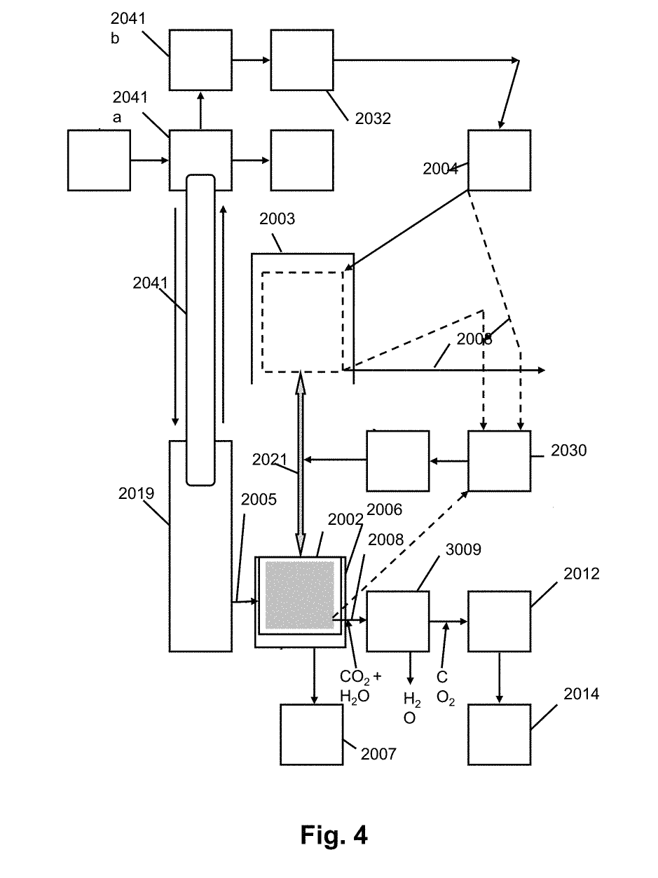

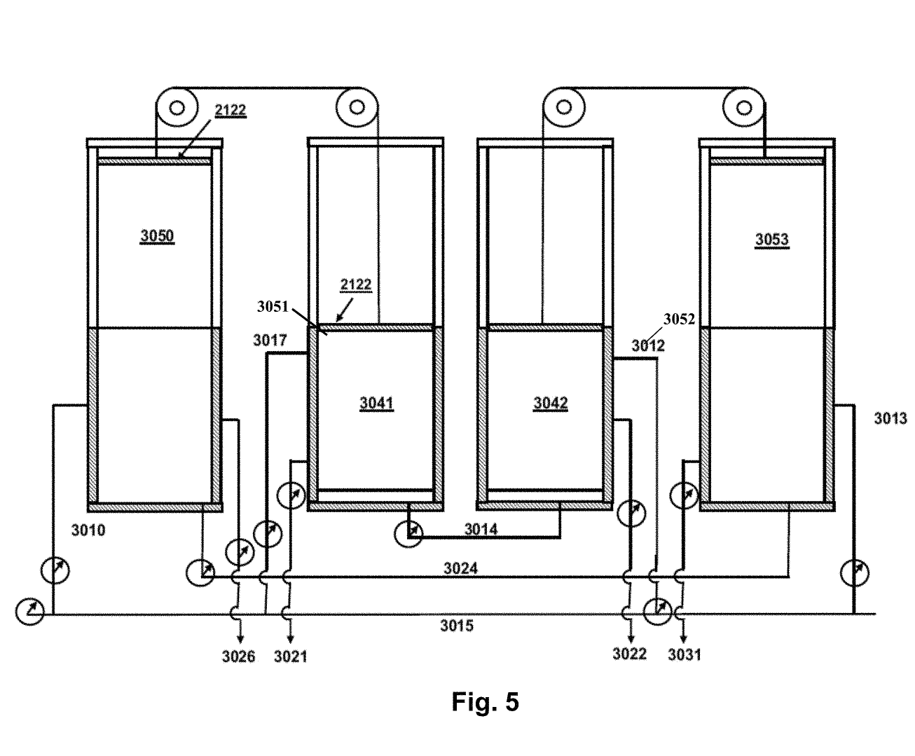

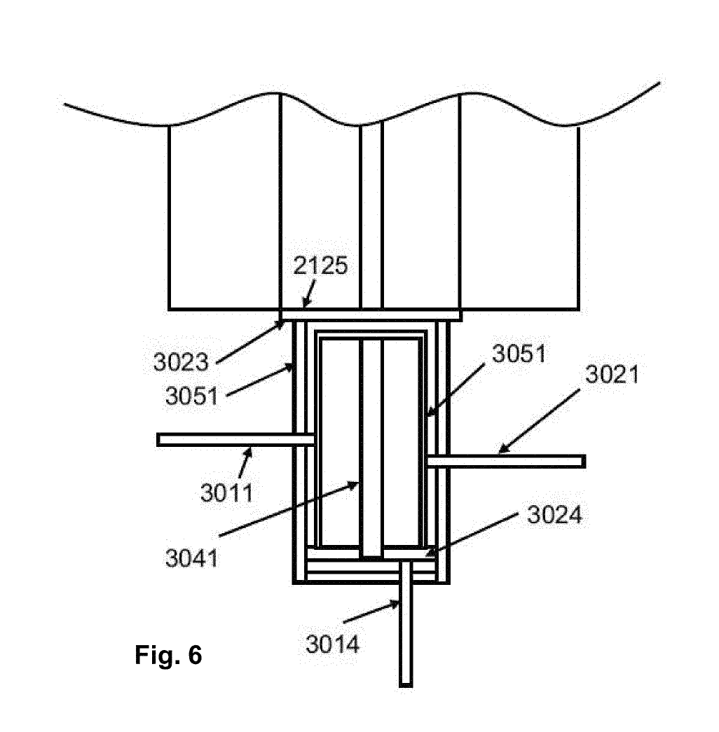

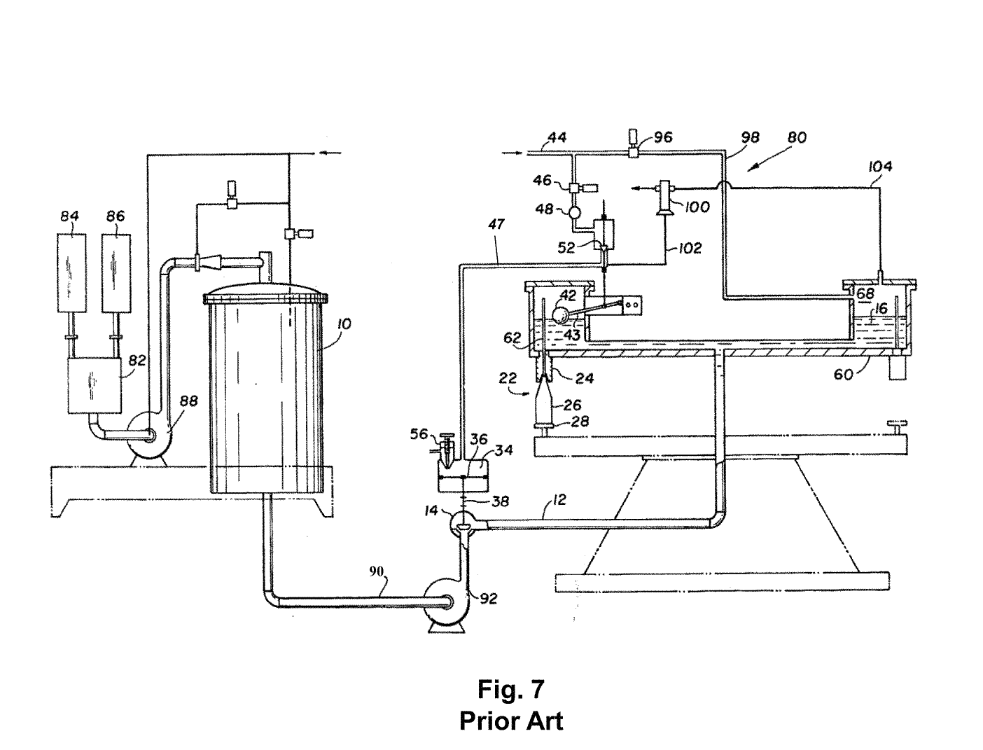

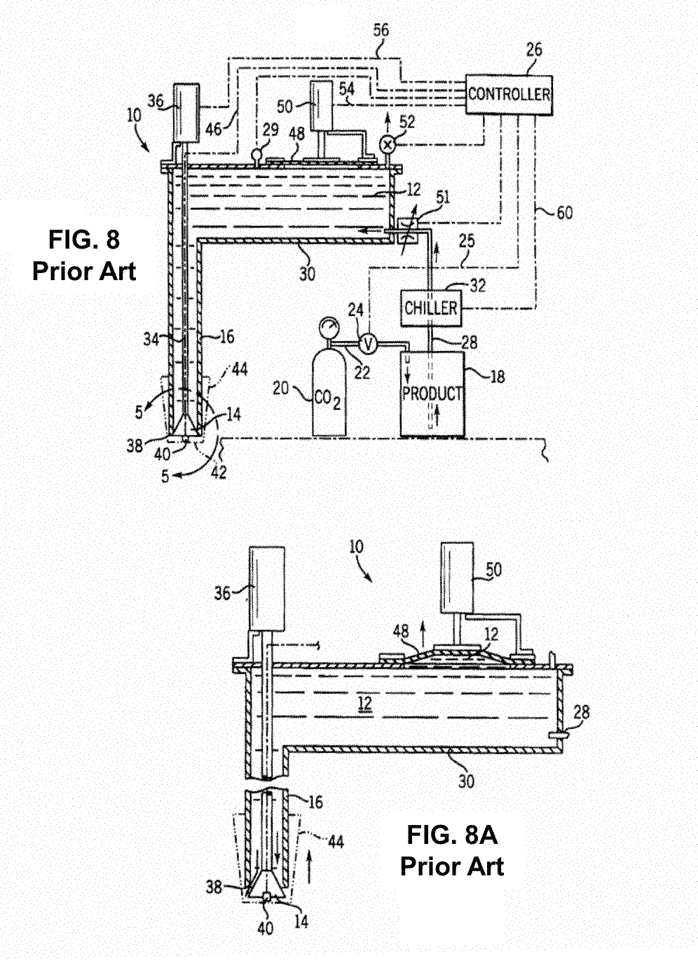

In addition to the drawings of the incorporated copending applications, copending applications Ser. Nos. 12/725,299, filed Mar. 16, 2010, and 61/330,108, filed Apr. 30, 2010, and 13/098,370, filed Apr. 29, 2011, and 61/643,103, filed May 4, 2012, the following drawings are most relevant to the present improved embodiments of the present invention:
a. FIG. 1, herein, is a generalized block diagram of a system for removing carbon dioxide from the atmosphere according to the present invention;
b. FIG. 2 is an example of a CSS Process, as designed for the Costain Group PLC;
c. FIGS. 3 and 4 present more specific flow diagrams showing the successive steps in a preferred system according to this invention for removing carbon dioxide from the atmosphere and obtaining a relatively low cost purified stream of CO₂; and finally pressurizing the purified CO₂ for storage in large but portable cylinders
d. FIG. 5 schematically illustrates the preferred tandem version of a system and technique for removing carbon dioxide from carbon dioxide laden air, and regenerating the sorbent that absorbs or binds the carbon dioxide, according to the principles of the present invention; where Absorption Time is approximately equal to Regeneration Time to achieve the greatest efficiency;
e. FIG. 6 schematically shows a cut-away side view of one of the tandem systems elevator structures of FIG. 4, showing the monolith in the regeneration chamber.
f. FIG. 7 presents a schematic view of a commercial beverage carbonation system using the atmosphere-derived CO₂ in accordance with the present invention, for forming and packaging the carbonated beverage from substantially room temperature water;
g. FIGS. 8 and 8A presents schematic views of a commercial beverage carbonation system using the atmosphere-derived CO₂ as part of the present invention, to form and dispense a chilled carbonated beverage into an open container for immediate consumption; and
h. FIG. 9 presents a front schematic view of the interior of a combined temperature-based pressure regulator for dispensing a carbonated beverage for immediate consumption.

### DETAILED DESCRIPTION OF THE INVENTION

Referring to the generalized block diagram of the process of the present invention shown in FIG. 1, Stage 1 provides for the pretreatment of a flue gas in a CCS-type of system and the admixture of the pretreatment effluent with a major proportion of ambient air as a flowing mass of ambient air having the usual relatively low concentration of CO₂ in the atmosphere, with a relatively low pressure drop (in the range of 100-1000) pascals. The flow of CO₂ containing air-flue gas mixture from Stage 1, is passed, in Stage 2, through a large area bed, or beds, of sorbent for the CO₂, each bed having a high porosity and on the walls defining the pores a highly active CO₂ adsorbent, i.e., where the adsorption results in a relatively high Heat of Reaction.

Such a highly active CO₂ sorbent is preferably a primary amine group-containing material, which may also have some secondary amine groups present. The primary amine groups are generally more effective at usual ambient temperatures in the range of from about 10-25° C. By utilizing all primary amine groups, especially in the form of polymers, one can maximize the loading. The relatively low concentration of CO₂ in the air (as opposed to flue gases), requires a strong sorbent. Primary amities have a heat of reaction of 84 Kj/mole of CO₂ that indicates stronger bonds, while the secondary amines only have a heat of reaction of 73 Kj/mole. Note that at lower ambient temperatures, e.g., −10 to +10° C., secondary amines would also be effective.

More generally, it should be noted that, broadly, the present invention is based not only on the effectiveness of the primary amines under ambient conditions, but also on the recognition that removing CO₂ from air under ambient conditions is practical, as long as the stripping of the CO₂ from the sorbent is equally practical at relatively low temperatures. Thus this invention contemplates the use of other sorbents having the desirable properties of the primary amines with respect to the air capture of CO₂. If in the future new sorbents are available that are not amine based but have the needed selectivity to capture CO₂ at concentrations characteristic of ambient or blended air, that have in addition advantages of lower cost and or longer lifetimes, than such sorbents would be used in the invention of the process described in this application.

As described above, an especially cost effective method for capturing CO₂ in a pure state from the atmosphere is to combine ambient air with an effluent gas from a flue outlet of an industrial process. As explained previously, capture of CO₂ from the a bi air is carried out under the relatively mild conditions of the a sphere which, in colder climates or in the winter season, can be below 10° C.

In Stage 3 of FIG. 1, the stripping of the CO₂ from the adsorbent and its final capture and purification is carried out at a temperature below 120° C. using preferably process heat steam. When the regenerated monolith or adsorbent is returned to the air capture position, the regenerated monolith substrate must have been cooled down to below 70° C. and be able to adsorb the higher concentration CO₂ without a temperature rise above that level. The stripped CO₂ is then pressurized and stored in large but portable containers for use by carbonated beverage producers.

In Stage 4 of FIG. 1, the pressurized and stored CO₂ is used to prepare carbonated beverages, both packaged for shipment and future use and for immediate use when dispensed into an open container.

FIGS. 3 and 4 depict an overall system for capturing CO₂ from ambient air, whether alone or admixed with a minor proportion of flue gas effluent taken, for example, from the pre-treatment system of FIG. 2. This system is described in greater detail in co-pending U.S. application Ser. No. 13/098,370, filed Apr. 29, 2011, with respect to 17A, B in that application, at paragraphs 078 et seq., and incorporated herein by reference as if fully repeated herein.

As shown in the detail of FIG. 5, the sealed regeneration box 3051 contains the monolith 3041 that has been regenerated using steam at a temperature of between about 100 and 120° C. At the same time, sealed box 3052 contains a monolith 3042 which has been lowered (after adsorbing CO₂ from the air-flue gas mixture) into paired regeneration box 3052; the regeneration box 3052 is then pumped out to lower the pressure in that regeneration box to about 0.1 Bar A, which allows for a saturated steam temperature of about 45° C. By lowering the box pressure, the ultimate result is the greater purity of the CO₂ stripped from the regenerated sorbent as the remaining quantity of air is not more than 10% of the original atmosphere pressure. Most of the remaining air may be caused to be exhausted by the incoming steam added to box 3041 to desorb the CO₂ from the monolith adsorbent and causing steam condensation to collect within the pores of the monolith 3041. The monolith 3041 during regeneration is maintained within a sealed regeneration tank chamber 3051, which is paired with a second regeneration chamber 3052, which can contain a second monolith 3042. The second monolith 3042 is so scheduled as to enter the regeneration box immediately after the first monolith 3041 has completed its regeneration in sealed chamber 3051. The system, as described in Provisional No. 61/643,103, generally utilizes a portion of the condensed steam in the first monolith 3041 which is flash evaporated when the connection between the sealed chambers 3052, 3051 is opened. This will cool the first monolith 3041 and preheat the second monolith 3042. This results in the desired lower temperature when the first monolith 3041 is returned to contact with ambient air, and thus avoid degeneration of the monolith and adsorbent as well as maintaining the low desorption temperature desirable when adsorbing at substantially ambient temperatures. The system as described in Ser. No. 61/643,103 is incorporated herein by reference as if fully repeated herein.

The primary amines work effectively at air capture (from atmospheric air containing normal concentrations of CO₂ found under ambient conditions). Experimental data confirm this. The loading of CO₂ on the amine adsorbent depends strongly upon the ratio of the heat of reaction/K (Boltzmann constant) T (temperature); the heat of reaction difference between primary and secondary amines, as shown above, can cause a factor of about 100 times difference in loading, following the well known Langmuir isotherm equation. The amine groups are preferably supported upon a highly porous skeleton, which skeleton may itself be substantially inert with respect to the sorption of CO₂, but which has a high affinity to the amines and upon or in which, the amines can be deposited.

Alternatively, the amine groups may be part of a polymer that itself forms the highly porous skeleton structure. A highly porous alumina structure is also very effective when used as the skeleton to support the amines. This ceramic skeleton has a pore volume and surface to achieve high loadings of amines in mmoles of amine nitrogen site per gram of porous material substrate. A preferred such skeleton support material has 230 cells per cubic inch with a thickness of six inches. Another structure that can be used is based upon a silica porous material known as cordierite and is manufactured and sold by Corning under the trademark CELCOR. CELCOR product is made with straight macro channels extending through the monolith, and the interior walls of the channels are coated with a coating of porous material, such as alumina, onto the walls of the pores of which the amine can be attached or deposited (and which is preferentially adherent to the amine compounds).

It is possible to reduce the cost of the process by making monolith thinner, and by increasing the density of primary amine groups per volume and thus requiring less monolith volume to achieve an adsorption time shorter than the time to move the bed between adsorption and regeneration and to carry out the steam stripping. This can be achieved by utilizing a monolith contactor skeleton that is made out of a primary amine-based polymer itself, but is also at least partially achieved by forming the structure of the monolith of alumina. Although alumina does not form as structurally durable a structure as does cordierite, for the conditions met at the ambient temperature of the air capture or the relatively low temperatures at which the CO₂ adsorbed on the amines at ambient temperatures can be stripped off, the structural strength and durability of alumina is adequate.

The foregoing modifications are important for air capture because they minimize the cost of making the structure as well as the amount of energy needed to heat the amine support structure up to the stripping temperature. Greater details are provided in U.S. Patent Publication No. 13/098,370. It is also useful to provide relatively thin contactors, with high loading capacity for CO₂ with rapid cycling between adsorption and regeneration, as is also explained in that application. Also see pending U.S. Provisional Application No. 61/643,103. This would use the tandem two bed version with one adsorbing and the other regenerating, utilizing flat pancake-like beds, having a preferred length, in the direction of the air flow, in the range of not greater than about 20 inches, to about 0.03 inch, or even thinner. The more preferred range of thickness is from not greater than about 8 inches, and most preferably not thicker than about 3 inches.

The computational model set forth in U.S. Publication No. 2011/0296872 provides a useful procedure for optimizing the efficiency of the CO₂ capture process and system of the present invention.

CO₂ laden air is passed through the sorbent structure, which is preferably pancake shaped, i.e., the dimension in the direction of the air flow is as much as two or more orders of magnitude smaller than the other two dimensions defining the surfaces facing in the path of the air flow, and the amine sites on the sorbent structure binds the CO₂ until the sorbent structure reaches a specified saturation level, or the CO₂ level at the exit of the sorbent structure reaches a specified value denoting that CO₂ breakthrough has started (CO₂ breakthrough means that the sorbent structure is saturated enough with CO₂ that a significant amount of additional CO₂ is not being captured by the sorbent structure) during the time of passage of air through the substrate.

When it is desired to remove and collect CO₂ from the sorbent structure (and to regenerate the sorbent structure), in a manner described further below in connection with FIGS. 3 through 6, the sorbent structure is removed from the carbon dioxide laden air stream and isolated from the air stream and from other sources of air ingress. Steam is then passed through the sorbent structure. The steam will initially condense and transfer its latent heat of condensation to the sorbent structure, as it passes from and through the front part of the sorbent structure, until the entire sorbent structure will reach saturation temperature; thereafter as additional steam contacts the heated sorbent, it will further condense (giving up its latent heat to the desorbed CO2, so that for each approximately two (2) moles of steam the condensing will liberate sufficient latent heat to provide the heat of reaction needed to liberate one (1) mole of the CO₂ from the primary amine sorbent. As the condensate and then the steam pass through and heat the sorbent structure, the CO₂ that was previously captured by the sorbent structure will be liberated from the sorbent structure; this condensation produces more condensed water to provide the needed heat of reaction to liberate the CO₂ from the sorbent structure and to push the CO₂ out of the sorbent structure so that it can be extracted by an exhaust fan/pump. This technique is referred to as “steam stripping”. The steam is passed through the sorbent structure to cause the release of the CO₂ from the sorbent; for energy efficiency cost reasons one would want to minimize the amount of steam used and that is mixed in with the CO₂ effluent. Thus, whatever is (or can be) condensed, upon exiting the regeneration chamber, the condensate can be added to that generated in the regeneration chamber, and recycled to be heated and converted back into steam for further use.

PUR—The Purity of the Collected CO₂—As a final performance factor, the purity of the CO₂ that is collected is significant in those situations where the stripped CO₂ is intended to be compressed for pipeline shipment, or to be used for food manufacturing or for potable beverages. The primary concern is about trapped air or noxious gas and not water vapor, which is easily removed in the initial stages of compression if the CO₂ is to be pipelined. For other uses where the carbon dioxide is not compressed significantly, such as a feed for algae or input to other processes, the presence of air is often not an issue. The purity of the CO₂ is primarily affected by the amount of air trapped in the capture system when it is subjected to the steam stripping or any gases remaining from the flow gases; therefore, this requires providing for the removal of such trapped gases before commencing the adsorption and especially before the stripping of the CO₂, e.g., introducing the stripping steam. Removing any trapped air is also desirable as the oxygen in the air can cause deactivation of the sorbent when the system is heated to the stripping temperature, especially in the presence of steam.

Oxygen, nitrogen and any noxious gases can be readily removed by pumping out the air from the support structure, to form at least a partial vacuum, before it is heated to the stripping temperature. As an unexpected advantage, when using primary amine groups as the sorbent, reducing the pressure in the sealed regeneration chamber does not immediately result in the correlative loss of any sorbed CO₂, when the sorbent is at the ambient temperatures, when the partial pressure is reduced by pumping. The CO₂ is not spontaneously released from the amine at such low temperatures. Such release, as has been shown experimentally, requires a stripping temperature of at least 90° C., at least where no steam is present.

This process can be carried out where the initial capture phase results in substantial saturation of the CO₂ on the sorbent, or until it results in only, e.g., about 60-80% of saturation by the CO₂. Avoiding complete saturation by CO2 substantially reduces the capture cycling time to an extent proportionally as much as 40%, so that the ongoing cycling of the process results in a greater extraction of CO₂ per unit time. Generally sorption slows as the sorbent more closely approaches saturation.

Details of preferred embodiments of this invention are given in the context of the above-recited prior pending applications.

FIGS. 3 through 6 are schematic illustrations of a system for carbon dioxide capture from an atmosphere, admixed with flue gases according to the principles of the prior inventions.

When a sorbent structure, such as a substrate 2002 carrying a primary amine sorbent, is in the CO₂ capture position (e.g. in zone 2003 in FIG. 3), carbon dioxide laden air is directed at the substrate (e.g. by a single large fan, or by a plurality of smaller fans, or by natural wind or convection currents), so that as the air flows through the substrate 2002 and into contact with the sorbent, the carbon dioxide contacts the sorption medium on the surfaces of the substrate 2002, and is substantially removed from the air. Thus, carbon dioxide laden air is directed at and through the substrate so that carbon dioxide in the air comes into contact with the sorbent medium, carbon dioxide is substantially removed from the air by the sorbent, and the CO₂-lean or leaner air from which the carbon dioxide has been substantially removed, is directed away from the substrate, back into the atmosphere.

In the embodiments of the above figures, the substrates are moved between the CO₂ capturing zone 2003 (in FIG. 3) and the CO₂ stripping/regeneration chamber 2006 (in FIG. 4). When a substrate is moved to the CO₂ stripping chamber 2006, i.e., the lower position as shown in FIG. 4, the substrate is at substantially ambient temperature, the heat of reaction of the sorption activity having been substantially removed by the convective effect of the blown mass of air from which the CO₂ was removed, and by the effects of condensate evaporation from the pores.

Any trapped air in the substrate 2002 and chamber 2006 can be pumped out, e.g., by an air evacuation pump 2007, or even by an exhaust fan, to form a partial vacuum in the chamber 2006. Next, process heat, e.g., in the form of saturated steam from the Steam co-generator 2019, is directed by conduit 2005 at and through the CO₂-laden substrate 2002 in the stripping chamber 2006.

Carbon dioxide is removed from the sorbent (stripped off) by the flow of relatively hot steam; the incoming steam is at a temperature of not greater than 130° C., and preferably not greater than 120° C., and most preferably not greater than 110° C. The vapor, comprising primarily carbon dioxide and some saturated steam, flows out of the stripping chamber 2006, through exhaust conduit 2008 into a separator 3009, where most of the steam present is condensed and drops out as water. The liquid condensed water is separated from the gaseous stripped CO₂. Some of the steam that is condensed in the sorbent structure itself during the stripping process either will be collected in a drain at the bottom of the regeneration chamber (e.g., by tipping the structure slightly off level) or preferably will be evaporated upon pumping out, and reducing the pressure in, the regeneration chamber following the completion of the steam stripping process. That evaporation of a portion of the condensed steam will cool down the sorbent structure before it is put back in contact with the air to capture more CO₂ (this also will mitigate the tendency of oxygen to deactivate the sorbent by oxidizing it). Some of the water condensed in the porous structure 2002 is returned to the contact zone 2003, where it can act to remove the heat of adsorption of the CO₂; cooling is also provided by the air flowing through the device in the adsorption step (this will depend upon the ambient humidity, further cooling the substrate). It has been shown experimentally, however, that the effectiveness of capture increases in the presence of moisture. This is well known to the art and results from the fact that dry sorbent must use two amine sites to bind CO₂ to the sorbent when dry, 50% amine efficiency, to only one amine binding site per CO₂ capture in the presence of high humidity, 100% potential amine efficiency. In addition, the presence of liquid water in the substrate acts to remove the heat of adsorption from the system (as the water evaporates), which is especially useful when the concentration of incoming CO₂ in the air is enhanced by mixing with a minor proportion of flue gas effluent. The potential amine efficiency may still be limited by pore blockage and the practical decision must be made of how much of the bed is to be saturated with CO₂ before one terminates the adsorption process and moves the sorbent structure to the regeneration step. It has been found to be more efficient to stop sorption before saturation in this type of multi-unit, continual operation, as the speed of adsorption drops sharply as the equilibrium point is approached.

The stripped CO₂ from the regenerated sorbent is in turn pumped into a storage reservoir 2012 where it can be maintained at slightly elevated pressure for immediate use, e.g., to provide CO₂-rich atmosphere to enhance algae growth, or the carbon dioxide gas can be compressed to higher pressures, by means of compressor 2014, for long term storage, bottled as high pressure CO₂, e.g., at above 160 psi, or to be pipelined to a distant final use, e.g., carbonation of water. During any initial compression phase, the CO₂ is further purified by the condensation of any remaining steam, which water condensate is in turn removed, by known means. In addition, the heat generated by compression, e.g., to 220 psi, is drawn off and can be used by adding to process heat.

For detailed examples of commercial CO₂-extraction facilities, e.g., large numbers of the modules scaled to a capacity to remove on the order of One Million (1,000,000) metric Tonnes of CO₂ per year from the atmosphere, see the prior commonly owned copending applications listed above. Such a facility will utilize at least approximately 500 such reciprocally moving substrate modules, where each module will have major rectangular surfaces extending perpendicular to the flow of air with an area of as much as about 50 square meters (preferably up to about 15 square meters), and a thickness, in the direction of flow, of most preferably not greater than about six (6) inches, but usually less, e.g., as low as 0.06 in. (3 mm). Each monolith module is preferably formed from brick-shaped monolith elements, each having the desired thickness of the module, but having a face surface of about 6 ins. by 6 ins., so that each substrate monolith module can be formed of as many as about 2000 such bricks, stacked together.

After the captured CO₂ has been pressurized to a pressure of at least 160 psi, and preferably up to 260 psi, the CO₂ can be stored, for example, in individual tanks which are readily portable and can be shipped to the carbonator or can be shipped via pipeline to a location where it would be used to fill tanks at the higher pressure and then sold to the ultimate user.

There are a great many processes for carbonating water. That which could be used in the home, usually involving very small “bottles” of CO₂ at a pressure of approximately 100 psi at room temperature, or it can be stored in large tanks five feet in height, usually used for commercial purposes or, if desired, in the home. The processes for carbonating and bottling water commercially are exemplified by the room temperature carbonation system in U.S. Pat. No. 4,253,502, granted Mar. 3, 1981 (the “'502 patent”).

The system for preparing room temperature carbonated beverages, as described in the '502 patent, is shown diagrammatically in FIG. 7 hereto. This prior art system provides for carbonation of what is substantially room temperature water, i.e., temperatures of, for example, 55-60° F. (15-20° C.) and provides energy savings by avoiding refrigeration. This is especially useful as the carbon dioxide storage systems are available at pressures substantially greater than is required for preparing these “warm fill” carbonated beverages. Generally, carbonated beverages contain approximately 3.8 volumes of CO₂ for a given liquid volume and in order to dissolve the CO₂ into the water requires a pressure of at least about 45 psi.

This '502 patent, from 1981, describes apparatus which provides for replenishment of a carbonated beverage supply in a closed filler bowl 60 made possible by the flowing of freshly carbonated beverage from a carbonator 10 through an inlet conduit 90,12 and suction pump 92, the inlet conduit having a normally open pressure-operated valve 14 to the filler bowl 60. The incoming beverage thereby restores any depleted level of the carbonated beverage in the filler bowl 60, until a selected elevated level in the storage container is reached, at which time the float 42 causes the appended lever arm 43 to open pressure valve 51 so that diaphragm 34 is exposed to gaseous pressure source via conduit 47, and closes the valve 14. The ambient air-derived CO2 is stored in the large tank 86, at high pressures, and is fed to the mixing tank 82 through a commercially available gas pressure regulator valve in line 83.

The apparatus further includes discharge conduit means 24 connected from the storage volume of the filler bowl 60 of the carbonated beverage to an arrangement of hollow bottles 26 at a filling station 28, where the bottles 26 can be filled. There is further provided a bottle-venting conduit 62 at each bottling station 28, which is operationally disposed in communication at opposite ends with a hollow interior of a bottle 26 and with the gaseous volume in filler bowl 60 during the filling of each bottle. This allows the gaseous pressure medium located in the head space or upper portion of the beverage storage filler bowl 60, to also effectively exert pressure upon the carbonated beverage filling each bottle by virtual contact through the bottle-venting conduit 62. Furthermore, as a preference, the pressure that operates to close the valve 14 is the same as is provided in the upper portion of the filler bowl 60. There is further provided a pump 92 for pumping carbonated beverage through the inlet conduit 90, 12 to the filler bowl 60 at a selected pressure when replenishing the volume level in the filler bowl 60. As a result, the carbonated beverage filling a bottle is under a balanced pressure from the choke means at the bottle inlet and under the pressure influence of the pressurized gas at the bottle vent 62, and thus the pressure is maintained stable in relation to the carbon dioxide content at an elevated temperature, i.e., room temperature, or 60° F. A more complete description of the operation of this system is set forth in U.S. Pat. No. 4,253,502 at column 3, line 4 through line 26 and column 6 beginning at line 5 where a description of the operation of FIG. 4 is provided.

FIGS. 8 and 8A depict a carbonated beverage dispenser for dispensing the beverage into an open container for immediate consumption, for example, at a restaurant or soda fountain. This system, as displayed in FIGS. 8 and 8A, provides for dispensing the beverage through a bottom-filling nozzle 32 into an open container, such as a cup 44. The carbonated beverage remains pressurized in chamber 30 until immediately before the dispensing valve 14 is opened and the pressurized beverage dispenses from the nozzle 16 into the open container 44. This system maintains the carbonated beverage at a desired pressure up until the moment of dispensing. Significantly in this case, this immediate dispensing into an open container requires that the beverage be chilled immediately prior to being dispensed, to a temperature preferably near or at the freezing point of the beverage. This low temperature is desirable in order avoid excessive foaming of the beverage upon dispensing and thus the immediate loss of the carbonated feature. A desirable temperature would be a maximum of 36° F., and preferably down to the surface temperature of ice, but without forming ice crystals. By dispensing into an open container through the nozzle 16, of course, the beverage is immediately exposed to atmospheric pressure. Again, a more detailed description of the operation of this dispensing system into an open container is described in U.S. Pat. No. 6,237,652 at column 2, beginning at line 6, and a description of the particular system of FIGS. 8 and 8A (which are FIGS. 1 and 2 of the '652 patent), begins at column 4, line 13.

The system 10 shown in FIGS. 8 and 8A (FIGS. 1 and 2 of the '652 Patent) operates generally in the following manner. The electronic controller 26 adjusts valve 24 in the pressurized carbon dioxide line 22 in order to force carbonated beverage from the source 18 into pressurized line 28 or, as mentioned, the initial system pressure can be set manually or by a conventional regulator on the carbon dioxide source. A typical pressure for pressurized line 28 would be 15-30 psi, although this pressure is discretionary. The in-line chiller 32 chills the pressurized carbonated beverage to a desired temperature (for example, 36.5 degrees Fahrenheit for certain beers, or the surface temperature of ice added to the open container for soft drinks or carbonated water). The chilled and pressurized carbonated beverage then flows through the flow restriction device 51 and into the pressurized chamber 30 and nozzle 16 with the valve 14 in a closed position as shown in FIG. 1. With the valve 14 closed, the pressure of the carbonated beverage in the nozzle achieves equilibrium pressure which is the same as the pressure in the pressurized line 28 and substantially greater than atmospheric pressure.

In order to dispense carbonated beverage into the open container 44, the open container 44 is placed underneath the nozzle 16 with the outlet port 38 for the nozzle 16 proximate the bottom 42 of the open container 44. The system 10 is then activated to initiate a dispensing cycle, for example by pushing the bottom 42 of the open container 44 against the activation switch 40 on the bottom of the valve head 14, or in accordance with a barcode system such as disclosed in incorporated U.S. Pat. No. 5,566,732, or by some other push button or electronic control. After system activation, the dispensing valve 14 is maintained in a closed position and the electronic controller 26 initiates the dispensing cycle. First, the electronic controller sends a control signal through line 54 to the bladder actuator 50 to retract the elastomeric bladder 48 and reduce the pressure of the carbonated beverage 12 contained in the nozzle 16 and chamber 30 to a lesser pressure that is appropriate for controlled dispensing of the carbonated beverage from the outlet port 38 of the nozzle 16 into the open container 44. Preferably, the retraction of the bladder 48, as shown in FIG. 8A, reduces the pressure of the carbonated beverage 12 in the nozzle 16 to a pressure slightly greater than atmospheric pressure, and in any event no more than 6 psi greater than atmospheric pressure. The valve head 14 is opened once the pressure of the carbonated beverage has been reduced to the selected dispensing pressure, thus allowing carbonated beverage to flow from the nozzle outlet port 38 into the open container 44 in a controlled manner as illustrated in FIG. 8A. Because the pressure of the carbonated beverage is known during the dispensing procedure, the amount of carbonated beverage filling the open container 44 accurately corresponds to the precise time period that the valve 14 is open. The dispensing valve 14 is closed after the predetermined time period. The presentation of the carbonated beverage within the open container 44 is likely to be extremely repeatable because the temperature and the dispensing pressure of the carbonated beverage are tightly controlled. Other features of the system 10 are described in connection with other FIGS. presented in U.S. Pat. No. 6,237,652, which help to improve the repeatability of the volume of the carbonated beverage presented to the open container 44.

Referring to FIG. 9, which is FIG. 1 of U.S. Pat. No. 7,377,495 (the “'495 ” patent), there is described a regulator assembly for achieving consistent performance with regard to temperature, foaming limits and carbonation level when dispensing into an open cup or like container. The regulator assembly shown in FIG. 9 (which is FIG. 1 of the '495 patent), describes an assembly having a pressure regulator and a temperature sensor so as to ensure that a proper pressure is applied to the carbonated beverage, for the temperature of the liquid, prior to dispensing and thus to avoid undesirable foaming and loss of carbonation immediately upon dispensing.

The operation of FIG. 9, and the generally desirable features of this system, are described beginning at column 5 line 24 through at least line 53 of column 6 of the '495 patent.

The above systems taken from prior patents are all intended to be exemplary of the types of systems for preparing and dispensing carbonated beverages utilizing the air-captured carbon dioxide of the present invention, into open containers for immediate use, or as part of a process for filling individual beverage containers for retail sale to consumers. The primary advantage of this invention is the use of a carbon dioxide obtained from and captured from the atmosphere so that when the beverage is dispensed, and the carbon dioxide is released into the atmosphere, there is a carbon zero footprint for this carbonated beverage, as the carbon dioxide is merely returning to the atmosphere from which it was captured.

The above merely set forth general descriptions and specific examples of the present invention, but the full scope of the invention is defined by the following claims.

The invention that is herein claimed is as follows:

1. A system for the preparation of carbon-neutral carbonated beverages utilizing carbon-neutral carbon dioxide, comprising:
a storage vessel of pressurized, purified carbon dioxide, where the carbon dioxide was captured from a gas supply comprising a mixture of gases selected from the group consisting of ambient air and a mixture of a major proportion of ambient air with a minor proportion of flue gas effluent, and is stored at a pressure of at least about 120 psi;
a source of flowing potable aqueous liquid at a lower pressure than the storage vessel of carbon dioxide;
a carbonator vessel in fluid flow connection with the source of flowing aqueous liquid and the storage vessel of pressurized, purified carbon dioxide, the fluid flow connections being controlled by suitable regulating valves to set the pressure in the carbonator dependent upon the temperature of the potable water;
and dispensing means for passing carbonated liquid from the carbonator to a container for immediate consumption or to a sealed container for storage and subsequent use;
the carbon dioxide being obtained from at least a major proportion of ambient air by a process comprising
providing energy to a primary production process with generated waste process heat;
heat exchanging waste process heat from said primary process with water to co-generate substantially saturated steam;
alternatively, repeatedly exposing a CO₂-sorbent to a mixture of gases selected from the group consisting of ambient air and a mixture of a major proportion of ambient air and a minor proportion of flue gas effluent, and process heat steam, in capture and regeneration system phases, respectively, so as to adsorb carbon dioxide from the gas mixture during said capture phase, and to regenerate sorbent and capture purified carbon dioxide from ambient air during the regeneration phase; and
compressing the purified, captured carbon dioxide, for storage, at least to the desired pressure for use in carbonation of potable aqueous liquids;
thereby enabling the preparation of carbon-neutral, carbonated water.

2. The system of claim 1 for the preparation of carbon-neutral carbonated beverages utilizing carbon-neutral carbon dioxide, wherein the carbon dioxide is captured from a gas supply comprising a major proportion of ambient air.

3. The system of claim 2 for the preparation of carbon-neutral carbonated beverages wherein captured carbon dioxide is stored at a pressure of at least about 160 psi.

4. The system of claim 1 for the preparation of carbon-neutral carbonated beverages utilizing carbon-neutral carbon dioxide, wherein the carbonated beverage is dispensed to an open container for immediate consumption.

5. The system of claim 1 for the preparation of carbon-neutral carbonated beverages utilizing carbon-neutral, carbon dioxide captured from ambient air.

6. The system of claim 5 for the preparation of carbon-neutral carbonated beverages utilizing carbon-neutral, carbon dioxide captured from ambient air, wherein the carbonated beverage is dispensed to a sealed container for storage and subsequent use.

7. The system of claim 1 for the preparation of carbon-neutral carbonated beverages utilizing carbon-neutral carbon dioxide and wherein the captured carbon-neutral carbon dioxide is stored at a pressure of at least about 160 psi.

8. The system of claim 1 for the preparation of carbon-neutral carbonated beverages utilizing carbon-neutral carbon dioxide, wherein the process heat steam is at a temperature of not greater than about 130° C.

9. The system of claim 1 for the preparation of carbon-neutral carbonated beverages utilizing carbon-neutral carbon dioxide, wherein the process heat steam is at a temperature of not greater than about 120° C.

10. The system of claim 2 for the preparation of carbon-neutral carbonated beverages utilizing carbon-neutral carbon dioxide, wherein the flue gas effluent is flue gas that was pre-treated to remove particulates and any noxious gases.

11. The system of claim 1 for the preparation of carbon-neutral carbonated beverages utilizing carbon-neutral carbon dioxide, wherein the CO2-sorbent comprises a porous substrate supporting an amine sorbent.

12. The system of claim 1 for the preparation of carbon-neutral carbonated beverages wherein the porous substrate comprises a porous silica monolith.

13. The system of claim 1 for the preparation of carbon-neutral carbonated beverages wherein the porous substrate comprises a porous alumina monolith.
